(19) United States
(12) Patent Application Publication
(10) Pub. No.: US 2002/0073958 A1
(43) Pub. Date: Jun. 20, 2002

(54) Two-cycle engine head for use with direct fuel injection

(76) Inventor: Christopher Wright, Thief River Falls, MN (US)

Correspondence Address: MERCHANT & GOULD PC, P.O. BOX 2903, MINNEAPOLIS, MN, 55402-0903, US

(21) Appl. No.: 09/798,663

(22) Filed: Mar. 2, 2001

Related U.S. Application Data
(60) Provisional application No. 60/186,823, filed on Mar. 3, 2000.

(51) Int. Cl. F02B 5/00

(52) U.S. Cl. 123/305

(57) ABSTRACT

A cylinder head for an internal combustion engine utilizing direct fuel injection, wherein the inner surface of the cylinder head defines a combustion chamber, the combustion chamber is asymmetrical about the centerline of the cylinder, a portion of the combustion chamber is symmetrical about a line angularly offset from the centerline of the cylinder, and wherein fuel is injected along a line angularly offset from the centerline of the cylinder from a location displaced perpendicularly from the centerline of the cylinder in the direction of the angular offset of the injection line, and wherein the inner surface of the cylinder head is smooth and continuous, and wherein the height of the combustion chamber is low relative to the width of the cylinder.

### FIELD OF THE INVENTION

This invention relates to an internal combustion engine head, and more particularly to a head which forms a combustion chamber designed to enhance scavenging and combustion in a high performance two-cycle engine with direct fuel injection (DFI). Such engines are suitable, for example, for use in recreational vehicles, in particular but not exclusively snowmobiles.

### BACKGROUND OF THE INVENTION

In a two-cycle internal combustion engine, a piston is disposed within a cylinder, which cylinder is connected at one end to a cylinder head. The surface of the cylinder head facing the inside of the cylinder defines a combustion chamber. In a direct fuel injection internal combustion engine, this surface typically has a recess in which a fuel injector and a spark plug are mounted. The combustion chamber is thus essentially in the shape of this recess. In each combustion cycle, fuel is injected by the fuel injector directly into the combustion chamber, to be ignited by the spark plug.

Typically, the recess, and thus the combustion chamber, are symmetrical about the centerline of the cylinder to which the cylinder head is connected, as illustrated in FIG. 1. The recess is commonly in the shape of a cone or dome centered on the centerline of the cylinder, is generally relatively deep, and usually has edges which are sharp or of relatively small radius. Typically the fuel injector is mounted on or near the centerline of the cylinder, and is oriented so as to discharge fuel at a shallow or zero angle to the centerline.

Following each ignition, the combustion of the fuel injected into the combustion chamber with the air therein produces exhaust gasses that must be scavenged, that is, removed from the combustion chamber. Present designs rely on looping airflow for scavenging. Air enters the cylinder through an intake port, loops up towards the cylinder head, and tumbles down and out through the exhaust port, carrying the exhaust gasses with it. In high performance engines, i.e. engines with relatively large ratios of horsepower to displacement, the exhaust pipes are typically tuned and produce compression and expansion waves in the combustion chamber.

However, at high throttle and moderate to high speeds the airflow through the combustion chamber can be so vigorous that it disrupts the spray of fuel from the fuel injector, forcing it away from the spark plug and against the cylinder head, thus disrupting normal combustion.

In addition, at part throttle and low to moderate speeds, a symmetrical recess tends to become isolated from the nearby flow of scavenging gas. Sharp edges on the recess and a relatively large height of the recess in comparison to the cylinder radius aggravate this effect. In addition, combustion is typically stratified, and thus deeper in the recess, at part throttle and low to moderate speeds. As a result of these factors, the exhaust gas build-up in the combustion chamber interferes with subsequent combustion cycles. Incomplete combustion results in decreases in engine power and fuel efficiency and an increase in pollutant output.

### SUMMARY OF THE INVENTION

Therefore it is the general purpose of the present invention to overcome the deficiencies of the existing designs. It is the purpose of the present invention to provide a cylinder head for use with direct fuel injection that is more efficient at scavenging exhaust gasses. It is also the purpose of the present invention to provide a cylinder head for use with direct fuel injection that is less susceptible to disruption of the fuel spray.

An aspect of the present invention comprises a cylinder head defining a combustion chamber that is asymmetrical about the centerline of the cylinder to which the cylinder head is connected. It is preferable that the combustion chamber be symmetrical about a line that is angularly offset from the centerline of the cylinder. It is more preferable that the combustion chamber be symmetrical about a line that is angularly offset from the centerline by at least 20 degrees, and still more preferably at least about 30 degrees.

Another aspect of the present invention comprises a cylinder head defining a combustion chamber wherein a fuel injector injects fuel along a line that is angularly offset from the centerline of the cylinder to which the cylinder head is connected. It is preferable that the angular offset be at least about 20 degrees, and more preferably at least about 30 degrees.

A further aspect of the present invention comprises a cylinder head defining a combustion chamber wherein a fuel injector is offset a distance from the centerline of the cylinder to which the cylinder head is connected, within a plane that is normal to the centerline of the cylinder, in the direction of the angular offset of the injector. It is preferable that the offset distance be about 25% of the diameter of the cylinder.

Yet another aspect of the present invention comprises a cylinder head defining a combustion chamber wherein the combustion chamber has a height of about 35% of the diameter of the cylinder to which the cylinder head is connected.

Still another aspect of the present invention comprises a cylinder head defining a combustion chamber wherein the combustion chamber has a surface that is generally smooth, without sharp angles or small radii.

These and various other advantages and features of novelty which characterize the invention are pointed out with particularity in the claims annexed hereto and forming a part hereof. However, for a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

FIG. 1 is a cross-section of an existing cylinder head for use with direct fuel injection.

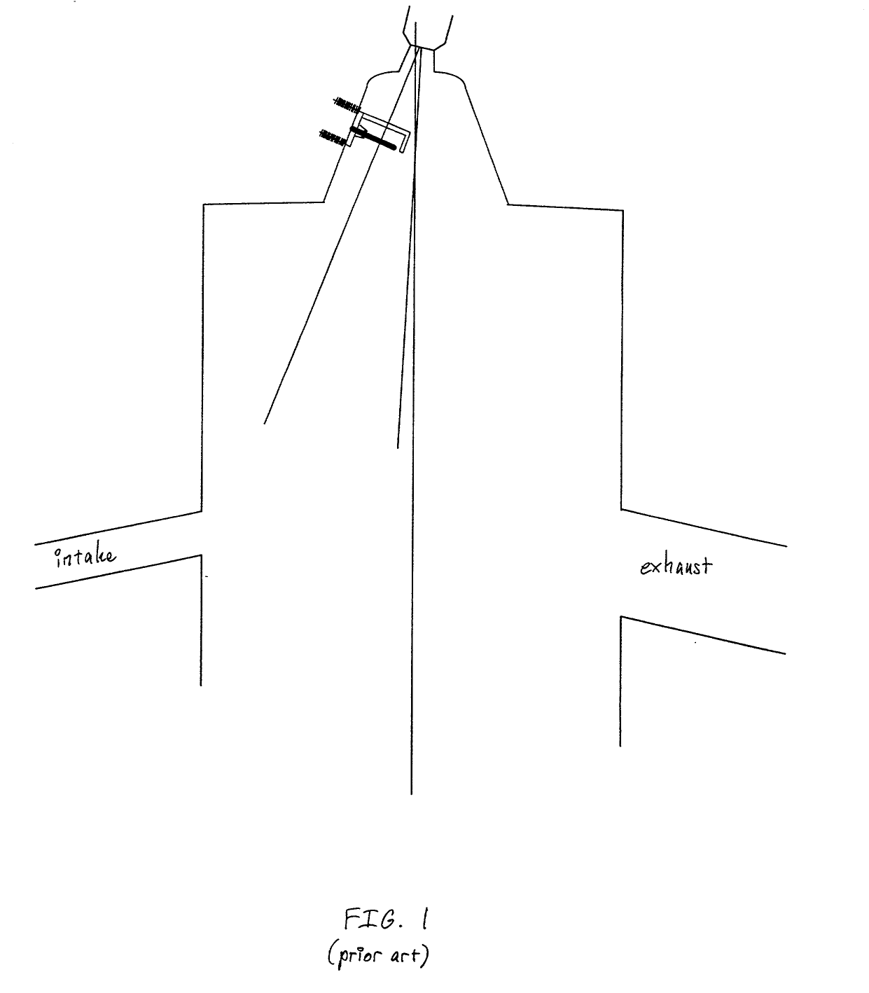

FIG. 2 is a cross-section of an embodiment of the present invention.

### DETAILED DESCRIPTION OF THE PREFERRED EMBODIMENT

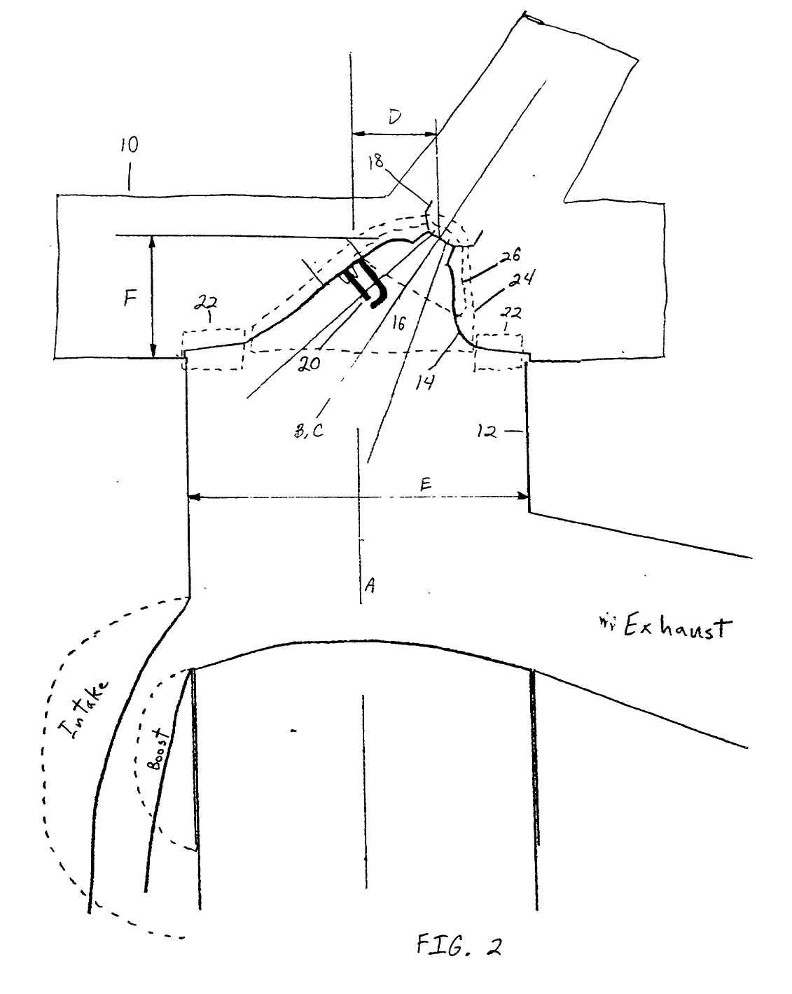

Referring to FIG. 2, the present invention comprises a cylinder head 10 for use within an internal combustion engine employing direct fuel injection. With regard to FIG. 2, the broken lines indicate areas identified subsequently by item numbers 22, 24, and 26. The cylinder head 10 is suitable for connection with a cylinder block defining a cylinder 12 that is symmetrical about a first line A. The cylinder head 10 comprises an inner surface 14 that defines a combustion chamber 16, and further comprises a means for injecting fuel 18 into the combustion chamber, e.g. a fuel injector nozzle, and a means for igniting fuel 20, e.g. a spark plug. The present invention is applicable to a variety of direct fuel injection systems. These generally are well-known, and are not described in detail herein.

In an embodiment of the invention, the inner surface 14, and therefore the combustion chamber 16, is asymmetrical with respect to the first line A. The inner surface 14 is comprised of a substantially planar portion 22 and a substantially concave portion 24.

A sub-portion 26 of the concave portion 24 may be generally symmetrical about a second line B. It is preferable that the second line B is angularly offset from the first line A. It is more preferable that the second line B is angularly offset from the first line A by at least about 20 degrees, still more preferably by at least about 30 degrees. This shape provides for efficient scavenging of exhaust gasses from the combustion chamber.

It is preferable that the means 18 for injecting fuel is oriented within said cylinder head 10 so as to inject fuel generally from a direction that is generally parallel to a third line C, wherein the third line C is angularly offset from the first line A. It will be understood by those with skill in the art that as it is desirable to inject fuel in a diffuse spray, rather than in a single line, the direction of the fuel injected is referred to with respect to the nominal center of the spray. It is more preferable that the angular offset of the third line C from the first line A is at least about 20 degrees more preferably at least about 30 degrees. This orientation reduces the amount of fuel that is blown against the side of the cylinder head, thereby improving the efficiency of the combustion process.

It is preferable that the means 18 for injecting fuel is positioned within the cylinder head 10 so as to inject fuel generally in a location that is displaced an offset distance D within a plane that is generally normal to the first line A, in the direction of the third line C. It will be understood by those with skill in the art that as it is desirable to inject fuel in a diffuse spray, rather than in a single line, the displacement of the fuel injected is referred to with respect to the nominal center of the spray. It is more preferable that the offset distance D is about 25% of a diameter E of the cylinder 12. This offset likewise improves the fuel distribution within the cylinder.

It is preferable that the inner surface 14 of the cylinder head 10 is smooth and continuous, and in particular that the concave portion 24 merges smoothly with the planar portion 22, without sharp angles or small radii. This smooth surface reduces turbulence in the vicinity of the combustion chamber, thereby permitting more efficient scavenging of waste gasses therefrom.

It is preferable that the height F of the combustion chamber is about 35% of the cylinder diameter E. The relatively low height renders the combustion chamber less susceptible to isolation from the scavenging airflow, and thus is less likely to allow buildup of exhaust gasses in the combustion chamber.

It is to be understood that while certain embodiments of the present invention have been illustrated and described, the invention is not limited to the specific forms or arrangements of the parts described and shown.

We claim:

1. A two-cycle internal combustion engine cylinder head suitable for connecting with a cylinder block, said cylinder block defining a cylinder that is generally symmetrical with respect to a first line, wherein said cylinder head comprises an inner surface defining a combustion chamber and a means for injecting a fuel into said combustion chamber, and said inner surface is generally asymmetrical with respect to said first line.

2. A cylinder head according to claim 1, wherein at least a portion of said inner surface is generally symmetrical about a second line, said second line being angularly offset from said first line.

3. A cylinder head according to claim 2, wherein said second line is angularly offset from said first line by at least about 20 degrees.

4. A cylinder head according to claim 3, wherein said second line is angularly offset from said first line by at least about 30 degrees.

5. A cylinder head according to claim 2, wherein said means for injecting said fuel is oriented so as to inject said fuel generally in a direction that is generally parallel to a third line, said third line being angularly offset from said first line.

6. A cylinder head according to claim 5, wherein said third line is angularly offset from said first line by at least about 20 degrees.

7. A cylinder head according to claim 6, wherein said third line is angularly offset from said first line by at least about 30 degrees.

8. A cylinder head according to claim 6, wherein said means for injecting fuel is positioned so as to inject said fuel at a location displaced an offset distance from said first line, said location is within a plane that is generally normal to said first line, said location is displaced said offset distance in a direction generally parallel to a projection of said third line on said plane.

9. A cylinder head according to claim 8, wherein said offset distance is about 25% of a diameter of said cylinder.

10. A cylinder head according to claim 8, wherein said inner surface is smooth and continuous.

11. A cylinder head according to claim 10, wherein said combustion chamber has a height of not more than about 35% of a diameter of said cylinder.

12. A two-cycle internal combustion engine cylinder head suitable for connecting with a cylinder block, said cylinder block defining a cylinder that is generally symmetrical about a first line, wherein said cylinder head comprises an inner surface defining a combustion chamber and a means for injecting a fuel into said combustion chamber; and
wherein said inner surface is generally asymmetrical with respect to said first line; and wherein at least a portion of said inner surface is generally symmetrical about a second line, said second line is angularly offset from said first line by at least about 20 degrees; and
wherein said means for injecting fuel is oriented so as to inject said fuel in a direction that is generally parallel to a third line, said third line being angularly offset from said first line by at least about 20 degrees; and
wherein said means for injecting fuel is positioned so as to inject said fuel at a location displaced an offset distance from said first line, said location is within a plane that is generally normal to said first line, said location is displaced said offset distance in a direction generally parallel to a projection of said third line on said plane, said offset distance is about 25% of a diameter of said cylinder; and
wherein said inner surface is smooth and continuous; and
wherein said combustion chamber has a height of not more than about 35% of said diameter of said cylinder.

13. A cylinder head according to claim 12, wherein said second line is angularly offset from said first line by at least about 30 degrees.

14. A cylinder head according to claim 12, wherein said third line is angularly offset from said first line by at least about 30 degrees.

15. A cylinder head according to claim 13, wherein said third line is angularly offset from said first line by at least about 30 degrees.

16. A two-cycle internal combustion engine, comprising a cylinder block defining at least one cylinder, wherein said at least one cylinder is generally symmetrical about a first line; and said engine further comprising at least one cylinder head suitable for engaging with said at least one cylinder in said cylinder block, wherein said at least one cylinder head comprises an inner surface defining a combustion chamber and a means for injecting a fuel into said combustion chamber; and
wherein said inner surface is generally asymmetrical with respect to said first line; and wherein at least a portion of said inner surface is generally symmetrical about a second line, said second line is angularly offset from said first line by at least about 20 degrees; and
wherein said means for injecting fuel is oriented so as to inject said fuel in a direction that is generally parallel to a third line, said third line being angularly offset from said first line by at least about 20 degrees; and
wherein said means for injecting fuel is positioned so as to inject said fuel at a location displaced an offset distance from said first line, said location is within a plane that is generally normal to said first line, said location is displaced said offset distance in a direction generally parallel to a projection of said third line on said plane, said offset distance is about 25% of a diameter of said cylinder; and
wherein said inner surface is smooth and continuous; and
wherein said combustion chamber has a height of not more than about 35% of said diameter of said cylinder.

17. An engine according to claim 16, wherein said second line is angularly offset from said first line by at least about 30 degrees.

18. An engine according to claim 16, wherein said third line is angularly offset from said first line by at least about 30 degrees.

19. An engine according to claim 17, wherein said third line is angularly offset from said first line by at least about 30 degrees.
